(19) United States
(12) Patent Application Publication
(10) Pub. No.: US 2012/0012022 A1
(43) Pub. Date: Jan. 19, 2012

(54) DEVICE AND METHOD FOR WARDING OFF OBJECTS APPROACHING A SHIP UNDER OR ON WATER

(75) Inventors: Christoph BORMANN, Bischofswiesen (DE); Martin FEGG, Bischofswiesen (DE)

(73) Assignee: RHEINMETALL WAFFE MUNITION GMBH, Unterluss (DE)

(21) Appl. No.: 13/044,333

(22) Filed: Mar. 9, 2011

Related U.S. Application Data
(63) Continuation-in-part of application No. PCT/EP2009/006330, filed on Sep. 2, 2009.

(30) Foreign Application Priority Data
Sep. 9, 2008 (DE) 10 2008 046 432.5

(51) Int. Cl. F42B 15/22; G01S 15/02; F42C 11/00; F42C 5/00; F42C 9/00

(52) U.S. Cl. 102/399

(57) ABSTRACT

A device is provided for warding off objects approaching a ship under or on water by using ammunition bodies to be detonated below the water surface, the device comprising: an ignition device programmable to the water depth at which ignition is to be carried out automatically. In order to selectively ward off objects approaching the ship, in the event of the presumption of a threat, the device may detect both the distance and the direction of the object approaching using an underwater positioning system, and transmitting the data to the actuators of a launching device of an ammunition launcher that is disposed on the ship, and positioned about two axes via a firing guide computer so that, after firing a respective ammunition body, the same strikes the water surface above the object at a precisely predefined region, or at a predetermined distance from the object.

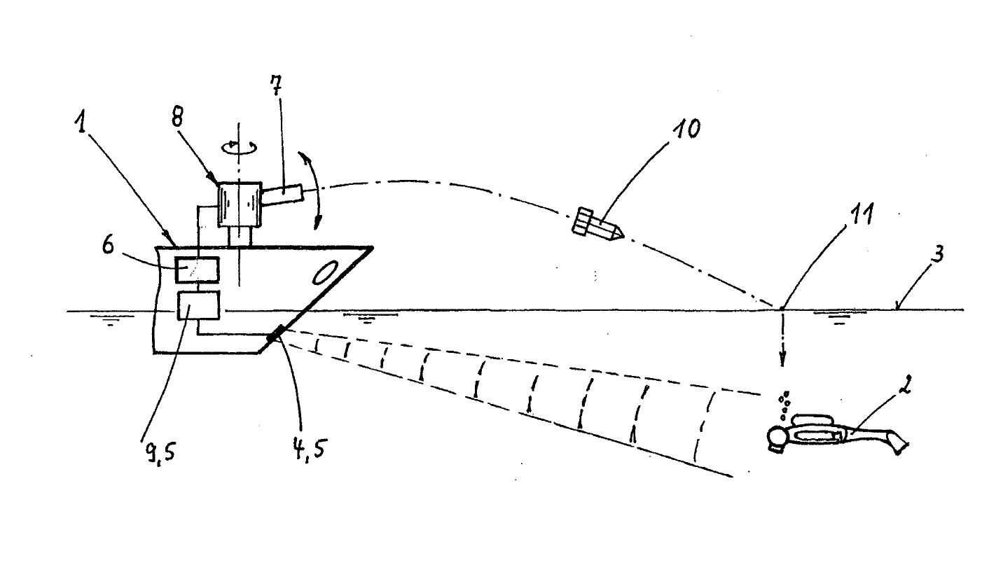

This is a Continuation-in-Part Application in the United States of International Patent Application No. PCT/EP2009/006330 filed Sep. 2, 2009, which claims priority on German Patent Application No. 10 2008 046 432.5, filed Sep. 9, 2008. The entire disclosures of the above patent applications are hereby incorporated by reference.

### FIELD OF THE INVENTION

The invention relates to an apparatus and a method for defense against objects that are approaching a marine vessel under, or on, the water, by means of munition bodies or a munition, which can be detonated under the water surface, having a fuze device, which makes it possible to program the water depth at which firing can take place automatically.

### BACKGROUND OF THE INVENTION

Apparatuses for defense against underwater objects approaching a marine vessel, such as submarines, torpedoes or attacking swimmers, have been known for a long time. For this purpose, when it is considered that there is a threat, depth charges or underwater grenades are fired in the direction of the supposed underwater object, for example, by means of a depth-charge launcher.

For example, even in the Second World War, anti-submarine weapons referred to as “Squid” were used, for which the launcher was initiated directly by means of a sonar rangefinder. In this case, after detection of an underwater object, three mutually independently acting depth charges were fired at a distance of about 250 m in front of the marine vessel. The three depth charges then formed a triangle with a side length of about 37 m. The explosion depth had to be set in advance in order to be the same in each case.

This known apparatus had the disadvantage, inter alia, that a plurality of depth charges had to be fired in each case. Although it was possible to continue to observe the underwater object using the sonar after firing, accurate location of the underwater object simply on the basis of the distance information obtained by the sonar was impossible. Therefore, if the sonar echo obtained from the underwater object remained constant, an immediate attack was required without any turning maneuvers with launchers launching to the side and to the rear. Considerable amounts of explosive, therefore, had to be used for the defensive measures, as a result of which the risk of inadvertent damage was very high.

DE 10 2007 048 072.7, which was not published prior to the priority date of this application, pursued the idea of using an artillery or mortar projectile, or explosive projectile, and of firing this into the target region by means of a large-caliber gun, for example, a Howitzer. A measure such as this one makes it possible to provide a defense against a submarine, or the like (for example an underwater mine), from a marine vessel or, possibly, from the land as well, over a distance of ≧30 km away from the target region. The projectile strikes the water surface and sinks deeper until the depth selected via a special fuze is reached. The projectile fuze may be a hydrostatic pressure fuze, which is triggered when the selected water depth is reached. However, depending on the application, different fuzes can also be used, (for example, proximity fuzes that act on the basis of the magnetic, acoustic, or hydrodynamic field of the target, or delayed-action fuzes, which respond once a selected time after immersion of the depth charge has elapsed).

The present invention is based on the objective of specifying an apparatus and a method by means of which, when it is believed that there is a threat, underwater objects approaching a marine vessel or objects approaching on the water can be attacked specifically from the marine vessel.

### SUMMARY OF THE INVENTION

According to the invention, this objective is achieved by the features of a first embodiment, which pertains to a method for defense against objects (2), which are approaching a marine vessel (1) under or on the water, by means of munition bodies or a munition (10), which can be detonated under the water surface (3), having a fuze device, which makes it possible to program the water depth at which firing can take place automatically, wherein the method has the following steps: (a) determination of the distance and the direction of the approaching object (2) with respect to the marine vessel (1); (b) determination of actuating signals for the actuating drives of a firing device (7) for the munition (10) with the aid of the determined position signals of the approaching object (2) and from the munition ballistics of the munition (10) used to attack the object (2), and its launch velocity; as well as (c) programming of the munition (10) with respect to the detonation time and/or detonation depth at which the munition (10) will be initiated (detonated). Furthermore, particularly advantageous refinements of the invention are disclosed in additional embodiments as follows.

In accordance with a second embodiment of the present invention, the first embodiment is modified so that the direction of the approaching object (2) can be determined with respect to the marine vessel (1) by the different distances between the location sondes (4) and the approaching object (2). In accordance with a third embodiment of the present invention, the first embodiment or the second embodiment is further modified so that the firing device (7) is directed by the actuating signals for the actuating drives so that, after firing, the munition (10) strikes the water surface (3) in a predefined area (11) above the object (2) or at a predetermined distance from the object (2).

In accordance with a fourth embodiment of the present invention, an apparatus is provided for defense against objects (2) that are approaching a marine vessel (1) under or on the water, by means of munition bodies or a munition (10), which can be detonated under the water surface (3), having a fuze device, which makes it possible to program the water depth at which firing can take place automatically, wherein the apparatus includes the following features: (a) the apparatus comprises an underwater location installation (5); (b) the underwater location installation (5) is connected via a computer (6) to the actuating drives of a firing device (7) of a munition launcher (8), which can be arranged on the marine vessel (1) and can be aimed about two axes; and (c) the munition (10), which is located in the firing device (7) in the munition launcher (8), is connected via an electrical connection to the computer (6) in order to program the detonation time and/or detonation depth. In accordance with a fifth embodiment of the present invention, the fourth embodiment is modified so that the underwater location installation (5) comprises a plurality of location sondes (4) at a distance from one another. In accordance with a sixth embodiment of the invention, the fourth embodiment or the fifth embodiment are further modified so that the approaching object type can be determined at least with the aid of one of the location sondes (4) of the underwater location installation (5).

In accordance with a seventh embodiment of the present invention, a munition (10) is provided, for use in an apparatus employed to perform the method pertaining to the first embodiment, the second embodiment, or the third embodiment of the present invention, is made so that the amount of explosive is chosen so that an underwater noise is produced for defense against an attacking swimmer, and, in the case of approaching boats etc., they are caused to stop and/or to reverse by the rising pressure wave. In accordance with an eighth embodiment of the present invention, the munitions employed according to the fourth embodiment of the invention include a delayed-action fuze, which is triggered once a selected time after immersion has elapsed. In accordance with a ninth embodiment of the present invention, the fourth embodiment and the fifth embodiments are further modified so that a hydrostatic pressure fuze is included, which is triggered on reaching the selected water depth after immersion.

The invention is essentially based on the idea of using an underwater location installation to determine both the range and the direction, and therefore also the depth, of an object approaching the marine vessel, and of transmitting this data to a fire control computer for a firing device, which can be aimed about two axes, for a munition launcher. The fire control computer then uses the position data of the object and the munition ballistics of the munition body (underwater grenade)/munition used to attack the object and its launch velocity to determine the data required to aim the firing device so that, after an appropriate munition body has been fired, this strikes the water surface in an accurately predefined area above the object or, in the case of an object approaching on the water, at a predetermined distance from this object. In addition, before the munition body is fired, the fire control computer programs the fuze device in the munition body so that the munition body is detonated at a predetermined depth after striking the water surface in order to destroy the underwater object, or to stop an object approaching on the water surface (for example, a boat loaded with explosives) and to force it to reverse as a result of the rising pressure wave.

By specifically attacking objects approaching the marine vessel in this way, considerably smaller amounts of explosive are required than is the case with known comparable apparatuses. In this case, the amount of explosive can also be chosen so that it does not, for example, kill an approaching attacking swimmer, but merely makes him incapable of combat. This avoids the risk of unintended death and other collateral damage.

The underwater location installation may, for example, consist of an active system, which determines both the distance to the approaching object and, by rotation of the location sonde, the direction of the object. However, a plurality of passive location sondes arranged at a distance from one another can also be provided for accurately determining the direction of the approaching object, with the distance between the location sondes being chosen so that the direction of the object can be determined by the different distances between the location sondes and the approaching object.

In order to optimally attack the approaching object, it has been found to be expedient for at least one of the location sondes of the underwater location device to be used to determine the approaching object type, (e.g., submarine, attacking swimmer, torpedo), thus allowing the munition to be fired to be chosen appropriately.

Further details and advantages of the invention will become evident from the following exemplary embodiment, which will be explained with reference to a figure.

### BRIEF DESCRIPTION OF THE DRAWING(S)

The figure schematically shows the bow of a marine vessel 1, which is being approached by an attacking swimmer 2 under the water, in order, for example, to attach a limpet charge, which can be fired remotely, to damage the marine vessel 1.

### DETAILED DESCRIPTION OF THE INVENTION

Location sondes 4 of an underwater location installation 5, as shown in the figure, are located under the water surface 3 on the hull wall of the marine vessel 1, and can be used to determine not only the distance to the attacking swimmer 2, but also the direction in which the attacking swimmer 2 is approaching the marine vessel 1 (and therefore also the depth at which the attacking swimmer 2 is located under the water surface 3). As shown in the figure, the location sondes (4) are devices for testing for the physical presence of an approaching object (2). In one embodiment, they may be embodied as one or more devices that produce pressure waves (i.e., sound waves) that are used to locate the object (2) by echolocation/sonar. More generally, a “sonde” in accordance with the present invention serves to detect the approach of an object by any means and, therefore, is a type of sensor. However, a “sonde” may be made up of one or more sensors. Thus, a “sonde” may be construed, in accordance with the present invention, as an assembly in which one or more sensors are contained.

The underwater location installation 5 is connected by means of appropriate lines via a fire control computer 6 to the actuating drives (not illustrated) of a firing device (in this case a firing barrel) 7 of a munitions launcher 8, which is located on the marine vessel 1 and can be aimed about two axes. As soon as the underwater location installation 5 has detected the attacking swimmer 2, the signals received with the aid of the location sondes 4 are supplied to a computer 9, which evaluates the signals and their propagation time differences, in a manner known per se. The position data obtained in this way is supplied to the fire control computer 6, which then uses the position data of the attacking swimmer 2 and the munition ballistics of the munition body/munition 10 used to attack the attacking swimmer 2, as well as its launch velocity, to determine the data required for aiming the firing device 7, and for the actuating drives of the firing device 7.

The firing device 7 is then aimed automatically in azimuth and elevation in accordance with the data determined by the fire control computer 6. In addition, a fuze device (for example a programmable pressure fuze) of the munition body 10, which is still located in the firing device, is programmed by the fire control computer, via an electrical connection, with respect to the water depth and detonation time and/or detonation depth at which the munition body 10 will be initiated. The electrical connection between the fire control computer and the fuze device may be of an inductive nature. Alternatively, known fuze-setting units can also be included.

After the munition body 10 has been fired, it strikes the water surface 3 in a predefined area 11 above the attacking swimmer 2 and then falls to the preset depth, at which it is detonated and the attacking swimmer 2 is rendered ineffective for combat. For this purpose, the munition or the munition body 10 may have a delayed-action fuze that triggers the munition on reaching the selected water depth after immersion, or after a selected time has elapsed, or after a selected depth has been reached, for example, by means of a hydrostatic pressure fuze.

### LIST OF REFERENCE SYMBOLS

1 Marine vessel
2 Attacking swimmer, underwater object, object
3 Water surface
4 Location sonde
5 Underwater location installation
6 Fire control computer
7 Firing device
8 Munition launcher
9 Computer
10 Munition body/munition
11 Area

1. A method for defense against objects that are approaching a marine vessel under water or on the water, wherein the defense employs munition bodies or a munition that can be detonated under the water's surface, wherein the munition bodies or the munition have a fuze device that makes possible programming of a water depth at which firing of the munition bodies or of the munition takes place automatically, wherein the method comprises the steps of:
(a) determining a distance and a direction of approach of an approaching object with respect to the marine vessel, and using the determined distance and direction of a proach of the approaching object to provide a plurality of determined position signals of the approaching object;
(b) determining actuating signals for a plurality of actuating drives of a firing device that fires the munition bodies or the munition, wherein the actuating signals are determined using the determined position signals of the approaching object, and by using munition ballistics and launch velocity of the munition bodies or the munition used to attack the approaching object; and
(c) programming the munition bodies or the munition with respect to a detonation time, or a detonation depth, or the detonation time and the detonation depth, at which the munition bodies or the munition are initiated.

2. The method as claimed in claim 1, wherein the direction of the approaching object is determined with respect to the marine vessel by using different distances between a plurality of location sondes and the approaching object.

3. The method as claimed in claim 1, wherein the firing device is directed by the actuating signals for the actuating drives so that, after firing, the munition strikes the water's surface in a predefined area above the object or at a predetermined distance from the object.

4. An apparatus for defense against objects that are approaching a marine vessel either under water or on the water, wherein the apparatus employs munition bodies or a munition that can be detonated under the water's surface, wherein the munition bodies or the munition have a fuze device that is programmable with respect to a water depth at which detonation takes place automatically, wherein the apparatus comprises:
(a) a firing device of a munition launcher;
(b) an underwater location installation that, is connected via a computer to actuating drives of the firing device of the munition launcher, wherein the munition launcher is arranged on the marine vessel and is aimable about two axes, wherein when
the munition bodies or munition are located in the firing device in the munition launcher, the munition bodies or munition are connected via an electrical connection to the computer in order to program a detonation time, or a detonation depth, or the detonation time and the detonation depth.

5. The apparatus as claimed in claim 4,
wherein the underwater location installation comprises a plurality of location sondes at a distance from one another.

6. The apparatus as claimed in claim 5,
wherein the apparatus determines the type of approaching object using at least one of the location sondes of the underwater location installation.

7. A munition for use in an apparatus for defense against objects that are approaching a marine vessel either under water or on the water, wherein the munition includes:
(a) an amount of explosive, wherein the amount of explosive is one that produces an underwater noise suitable for defense against an attacking swimmer, or the amount of explosive is one that produces a rising pressure wave suitable to cause approaching boats to stop, or to reverse, or to stop and reverse, due to the rising pressure wave, wherein the munition is configured for firing from the apparatus for defense against objects as claimed in claim 4.

8. The munition as claimed in claim 7, further including:
(b) a delayed-action fuze that is triggered once a selected time after immersion of the munition has elapsed, wherein the delayed-action fuze is operably connected to detonate the amount of explosive.

9. The munition as claimed in claim 7, further including:
(b) a hydrostatic pressure fuze that is triggered on reaching a selected water depth after immersion of the munition. wherein the hydrostatic pressure fuze is operably connected to detonate the amount of explosive.

10. The method as claimed in claim 2, wherein the firing device is directed by the actuating signals for the actuating drives so that, after firing, the munition strikes the water's surface in a predefined area above the object or at a predetermined distance from the object.

11. The apparatus as claimed in claim 4, wherein the apparatus determines the type of approaching object using at least one of a plurality of location sondes of the underwater location installation.

12. A munition for use in an apparatus for defense against objects that are approaching a marine vessel either under water or on the water , wherein the munition comprises:
(a) an amount of explosive that produces an underwater noise suitable for defense against an attacking swimmer, or an amount of explosive that produces a rising pressure wave suitable to cause approaching boats to stop, or to reverse, or to stop and reverse, due to the rising pressure wave, wherein the munition is configured for firing from the apparatus for defense against objects as claimed in claim 5.

13. The munition as claimed in claim 8, further including:
(c) a hydrostatic pressure fuze that is triggered on reaching a selected water depth after immersion of the munition, wherein the hydrostatic pressure fuze is operably connected to detonate the amount of explosive.
